(19) United States
(12) Patent Application Publication
(10) Pub. No.: US 2006/0080154 A1
(43) Pub. Date: Apr. 13, 2006

(54) Method of verifying insurance claims

(76) Inventor: Donovan Roy Larsen, Surrey (CA)

Correspondence Address: Meridian Patent Services, 471 - 7231 - 120th Street, Delta, BC, V4C 65, CA

(21) Appl. No.: 11/190,046

(22) Filed: Jul. 27, 2005

Related U.S. Application Data
(60) Provisional application No. 60/591,093, filed on Jul. 27, 2004.

(51) Int. Cl. G06Q 40/00

(52) U.S. Cl. 705/4; 707/10

(57) ABSTRACT

A method of evidencing loss or damage an under a policy of insurance provided by an insurer to an insurance policy holder is disclosed. The policy provides insurance against loss of or damage to one or more insured properties. The method includes providing an insurance policy holder with a claim verification package, the package including a camera and information identifying an insurance policy. A database is maintained by an information management facility which keeps database records identifying the insurance policy, image records of the insured property or properties which may be provided both after and/or prior to and after loss or damage to the property or properties. Authorized users have access to the database records.

### CROSS-REFERENCE TO RELATED APPLICATIONS

This application is related to U.S. provisional application No. 60/591,093 filed Jul. 27, 2004, entitled “Method of Identifying Insurance Claims”, naming Donovan Roy Larsen as the inventor. The contents of the provisional application are incorporated here by reference in their entirety, and the benefit of the filing date of the provisional application is hereby claimed for all purposes that are legally served by such claim for the benefit of the filing date.

### BACKGROUND OF THE INVENTION

In the motor vehicle insurance industry, the reliable verification of accident claims and the reliable verification of responsibility for accidents can be problematic. Not infrequently, insurance assessors and others who may be concerned (e.g. the police) are required to rely on the verbal recollection of those who were directly involved in the accident and on accounts from third party witnesses. In many cases, recollection can be inaccurate. As well, memory can quickly fade.

Of course, it is not uncommon to take photographs of an insured item either before or after loss or damage occurs. However, there is generally no systematic way to motivate insured people to take pictures or to reliably and independently manage the handling and subsequent use of such pictures if they are taken. As a result, the verification of insurance claims often can be unnecessarily inefficient and unreliable.

### SUMMARY OF THE INVENTION

In accordance with the present invention, there is provided a method of evidencing loss or damage under a policy of insurance provided by an insurer to an insurance policy holder, the policy providing insurance against loss of or damage to one or more insured properties. Insured properties may be any insurable items. For example, they may include a vehicle such as an automobile, truck, motorcycle, boat, aircraft, etc., or a vehicle accessory such as a trailer. Or, they may include buildings such as a house, a barn, a commercial building, or other structure built on land. Or, they may include personal chattels or other effects such as the contents of a home or other building, valuables such as jewelry, paintings and so forth. The method comprises the steps of:
(a) providing an insurance policy holder with a claim verification package, the package including a camera and information identifying an insurance policy;
(b) recording with the camera one or more image records of an item insured under the policy;
(c) delivering the one or more image records and the information identifying the insurance policy to an information management facility, the facility including a computer programmed with a database, the computer including means cooperative with the database for receiving and storing data in the database and means for permitting data so stored to be read from the database;
(d) storing in the database data corresponding to the information identifying the insurance policy;
(e) storing in the database data corresponding to the one or more image records;
(f) relating in the database the stored data corresponding to the information identifying the insurance policy with the stored data corresponding to the one or more image records;
(g) linking a viewing terminal located remote from the computer to the computer over a data communication path; and,
(h) permitting authorized users utilizing the viewing terminal to access and read the stored data corresponding to the information identifying the insurance policy and the stored data corresponding to the one or more image records.

Advantageously, the information management facility and the insurer are not one and the same. An insurer while wanting the benefit of information managed in the above manner may not want to be burdened by the task. Further, an insurer may be considered to have a real or potential conflict of interest if responsible not only for providing compensation in the event of loss or damage but also for processing and managing evidence of such loss or damage.

To further advantage, the data communication path noted above may comprise the Internet thereby enabling authorized users to connect with the database over the Internet utilizing a personal computer and its associated display (viz. viewing terminal). Authorized users may include not only the insured, but also the insurer and others (e.g. the police) who may be approved to have access.

Of course, a given policy of insurance may cover many insured items. Accordingly, having stored data in the above database for one item, the method may further comprise storing data for one or more additional items.

The invention will now be described in more detail with reference to the drawings.

### BRIEF DESCRIPTION OF THE DRAWINGS

FIG. 1 is the first page of an exemplary four page accident report form forming part of a claim verification package for the case where the insured property is a motor vehicle.

FIG. 2 is the second page of the accident report form.

FIG. 3 is the third page of the accident report form.

FIG. 4 is the fourth page of the accident report form.

### DETAILED DESCRIPTION

Typically, a given policy of insurance will have a unique policy number. Thus, in the method steps described above, it is generally contemplated that the database should be a relational database in which all records are operatively linked to the same policy number. For any one insured item which has more than one image record, or for any one policy of insurance which covers more than one item each of which may have one or more image records, this avoids having to repetitively store the same data (e.g. name and address of the insured, name and address of the insurer, insurance policy number etc.) for each image record. The design and structure of relational databases to manage, receive and store data, and to permit authorized persons to access, view and/or print such data utilizing a suitably connected computer or other communication terminal, is well known to those skilled in the art.

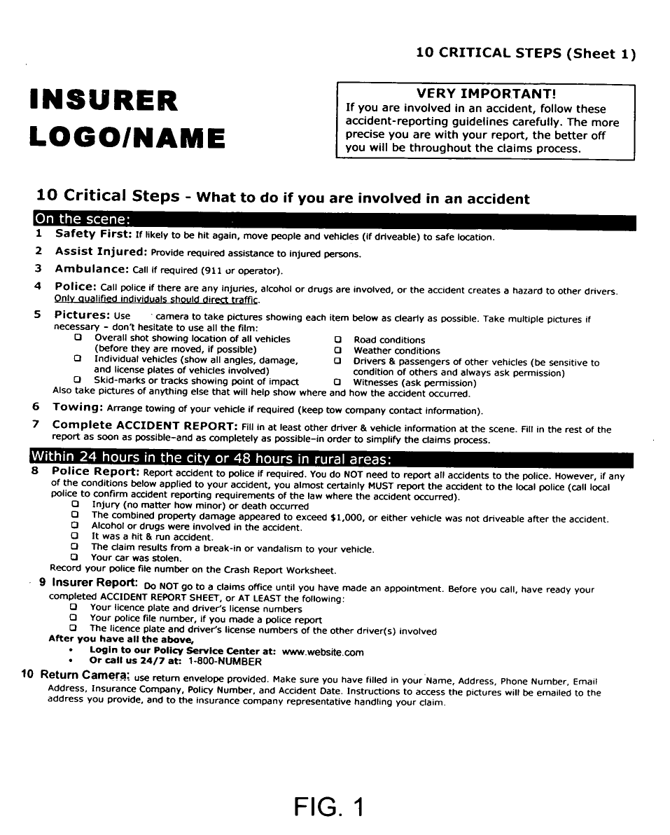

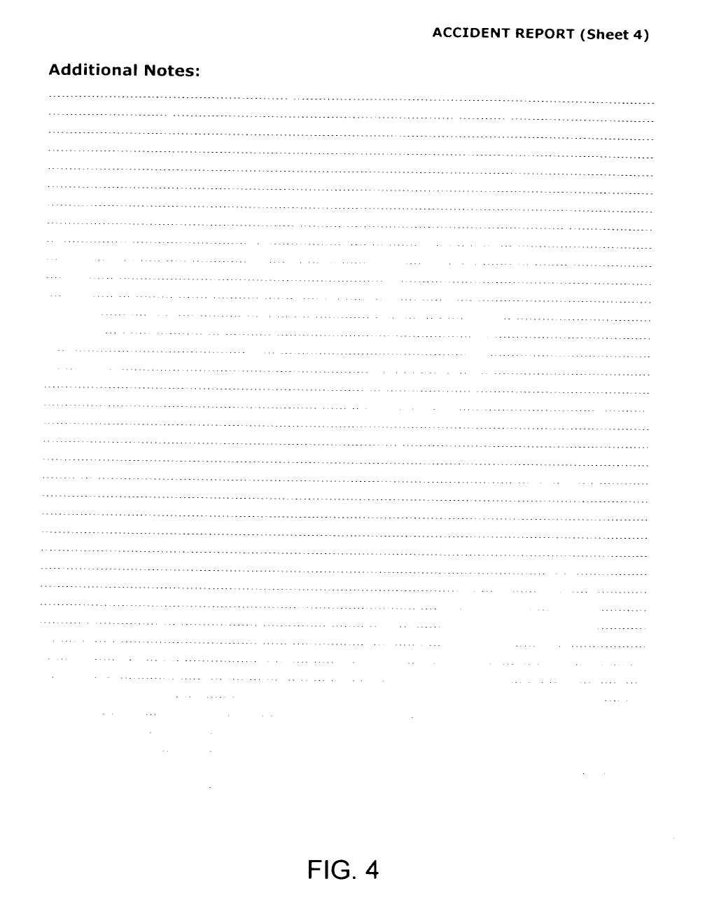

In the case of an insured vehicle, it is generally contemplated that the claim verification package referred to above will be carried in the vehicle itself—to be used in the event that an accident occurs. Advantageously, the package includes an accident report form as shown by way of example in FIGS. 1 to 4. This form is in addition to a camera and information identifying the related insurance policy. It is illustrated in a generic manner but may be customized to identify a particular insurer.

It is to be understood that the content and wording of the form illustrated in FIGS. 1 to 4 is exemplary. In any given case, a particular insurer may elect to adopt an accident report form which is substantially different in format, content and wording.

FIG. 1, (the first page of the form) basically comprises a set of instructions which indicate seven “Critical” steps “On the scene” (viz. of an accident) and three “Critical” steps “Within 24 hours in the city or 48 hours in rural areas”. The word “critical” does not mean “essential”. It is word chosen to capture and focus the attention of the policy holder on those matters which should systematically receive attention in circumstances where he/she may be highly agitated. While preferred, it is to be understood that the choice of the word “critical” is optional, as are the particular ten steps and timelines which are set out in FIG. 1.

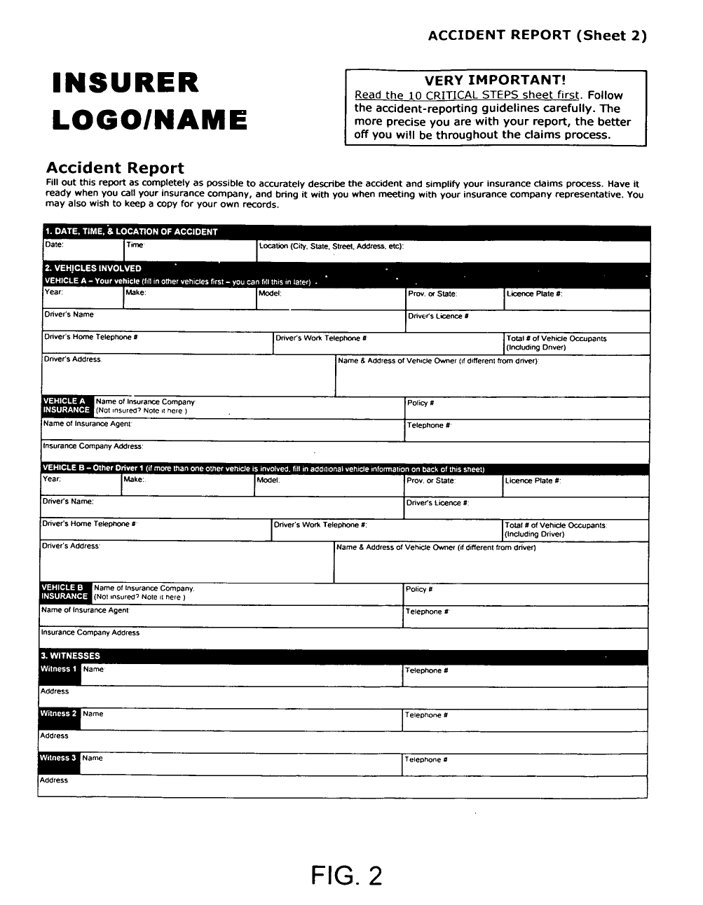

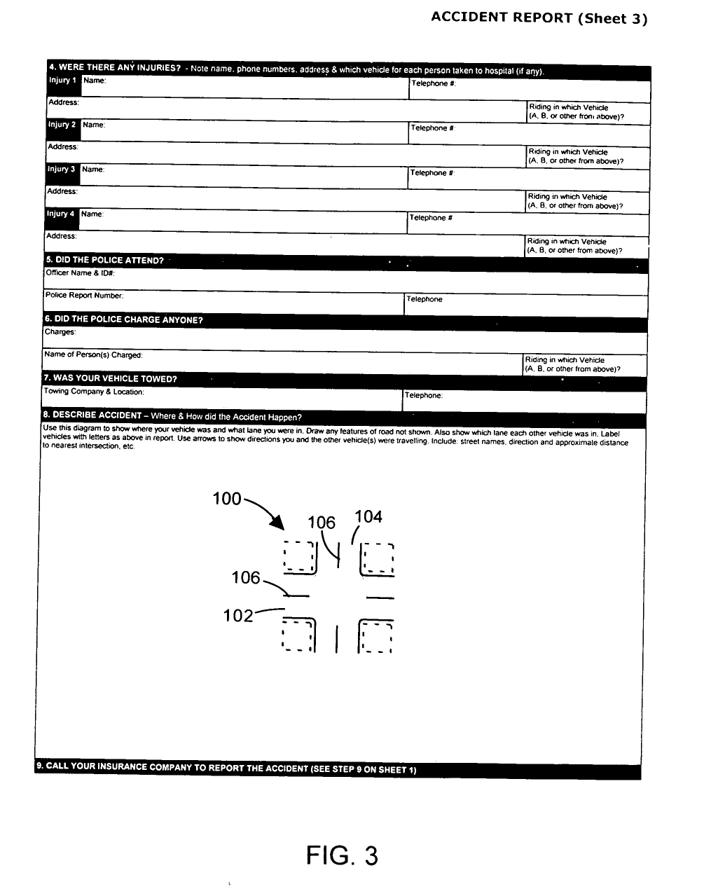

FIGS. 2, 3 and 4 (the second, third and fourth pages of the form) enable an insured to report on the circumstances of damage that has occurred, including date, time and location; vehicle(s) involved; particulars of insurance; witnesses; instructions on reporting to the police and to the insurer; etc. In FIG. 3, a graphic is provided for use in the event that an accident occurred at an intersection. Normally, it is contemplated that the numeric labeling and lead lines shown in FIG. 3 would not appear in an actual accident report. However, for purposes of illustration, FIG. 3 illustrates an intersection generally designated 100 between a street 102 and a cross-street or avenue 104, each of which have lanes divided by center lines 106.

In accordance with the present invention, the pictures taken under instruction 5 in FIG. 1 are delivered to the information management facility. The completed accident report form (FIGS. 2 to 4) or a copy thereof may be delivered concurrently, all for example in a prepaid courier envelope addressed to the information management facility. In cases where a completed accident report form is included, the method of the present invention preferably further includes scanning and storing a copy of the accident report form in the database and relating the stored copy to the stored data identifying the insurance policy. Alternately, information from the accident report form may be extracted and entered into the database.

Apart from vehicle accident insurance, the method of the present invention generally contemplates that the camera provided with the verification package will be used to take pictures of insured items before any loss or damage occurs. This will serve not only to help verify the condition of the item before the onset of loss or damage but also the existence of the item—thereby mitigating against insurance fraud. By storing image records of insured items with an information management facility in accordance with the present invention, the records are conveniently maintained in a central location that may be accessed by both the insured and the insurer. They can serve as a convenient and reliable remote backup to other records that may exist.

Elements of the present invention may be embodied in hardware and/or software as a computer program code that may include firmware, resident software, or the like. Additionally, elements of the present invention may take the form of a computer program product on a computer-usable or computer-executable storage medium.

A variety of modifications, changes and variations to the invention are possible within the spirit and scope of the following claims, and will undoubtedly occur to those skilled in the art. The invention should not be considered as restricted to the specific embodiments that have been described and illustrated with reference to the drawings.

I claim:

1. A method of evidencing loss or damage under a policy of insurance provided by an insurer to an insurance policy holder, said policy providing insurance against loss of or damage to an insured property, said method comprising the steps of:
(a) providing an insurance policy holder with a claim verification package, said package comprising a camera and information identifying an insurance policy;
(b) recording with said camera one or more image records of a property insured under said policy;
(c) delivering said one or more image records and said information identifying said insurance policy to an information management facility, said facility including a computer programmed with a database, said computer including means cooperative with said database for receiving and storing data in said database and means for permitting data so stored to be read from said database;
(d) storing in said database data corresponding to said information identifying said insurance policy;
(e) storing in said database data corresponding to said one or more image records;
(f) relating in said database said stored data corresponding to said information identifying said insurance policy with said stored data corresponding to said one or more image records;
(g) linking a viewing terminal located remote from said computer to said computer over a data communication path; and,
(h) permitting authorized users utilizing said viewing terminal to access and read said stored data corresponding to said information identifying said insurance policy and said stored data corresponding to said one or more image records.

2. A method as defined in claim 1, wherein said data communication path comprises the Internet.

3. A method as defined in claim 1, wherein said one or more image records comprise one or more image records created subsequent to damage to said property.

4. A method as defined in claim 3, wherein said insured property comprises a vehicle and wherein said claim verification package comprises a report form for reporting on the circumstances of any damage to said vehicle, said method further comprising:
(a) in the event of damage to said vehicle, completing said report form with information reporting on the circumstances of such damage and delivering said report form when completed to said information management facility;
(b) storing in said database data corresponding to information provided in said report form;
(c) relating in said database said stored data corresponding to said information identifying said insurance policy with said stored data corresponding to said information provided in said report form; and,
(d) permitting authorized users utilizing said viewing terminal to access and read said stored data corresponding to said information provided in said report form.

5. A method as defined in claim 1, wherein said one or more image records comprise one or more image records created prior to any loss of or damage to said property.

6. A method as defined in claim 5, wherein said one or more image records further comprise one or more image records created subsequent to damage to said property.
